(19) United States
(12) Patent Application Publication
(10) Pub. No.: US 2018/0071820 A1
(43) Pub. Date: Mar. 15, 2018

(54) REVERSIBLE BINDERS FOR USE IN BINDER JETTING ADDITIVE MANUFACTURING TECHNIQUES

(71) Applicant: General Electric Company, Schenectady, NY (US)

(72) Inventors: Arunkumar Natarajan, Niskayuna, NY (US); Rajendra Madhukar Kelkar, Mason, OH (US); Jeffrey Jon Schoonover, Colonie, NY (US); Prabhjot Singh, Rexford, NY (US); Venkat Subramaniam Venkataramani, Clifton Park, NY (US); Kwok Pong Chan, Niskayuna, NY (US); John Leman, Schenectady, NY (US)

(21) Appl. No.: 15/261,547

(22) Filed: Sep. 9, 2016

(51) Int. Cl. B22F 3/10; B22F 1/00; B33Y 10/00; B33Y 40/00; B33Y 80/00; C09D 133/12; C09D 125/06; C09D 169/00; C09D 129/04

(52) U.S. Cl. CPC B22F 3/1021; B22F 1/0062; B33Y 10/00; B33Y 40/00; B33Y 80/00; B22F 2998/10; C09D 125/06; C09D 169/00; C09D 129/04; B22F 2302/45; C09D 133/12

(57) ABSTRACT

A method of binder jet printing a metal part includes depositing a layer of a metal powder on a working surface of a binder jet printer and selectively printing a binder solution having a reversible binder into the layer of metal powder in a pattern to generate a printed layer. The pattern is representative of a structure of a layer of the metal part. The method also includes curing the reversible binder in the printed layer to generate a layer of a green body metal part and heating the green body metal part above a first temperature to remove a substantial portion of the reversible binder and generate a brown body metal part. The reversible binder is thermally decomposed to generate oligomers that remain within and strengthen the brown body metal part. The method further includes heating the brown body metal part above a second temperature to remove the oligomers and sinter the metal powder to generate the metal part. The metal part is substantially free of char residue.

### BACKGROUND

The subject matter disclosed herein relates to additive manufacturing, and more particularly, to thermoplastic binders for use in binder jetting additive manufacturing techniques.

Additive manufacturing, also known as 3D printing, generally involves printing an article one layer at a time using specialized systems. In particular, a layer of a material (e.g., a metal powder bed) may be deposited on a working surface and bonded with another layer of the same or a different material. Additive manufacturing may be used to manufacture articles (e.g., fuel nozzles, fuel injectors, turbine blades, etc.) from computer aided design (CAD) models using techniques such as, but not limited to, metal laser melting, laser sintering, and binder jetting. These additive manufacturing techniques melt, sinter, or chemically bind layers of material to generate the desired article. Additive manufacturing may facilitate manufacturing of complex articles and enable flexibility for customization of articles compared to techniques such as molding (e.g., cast molding, injection molding). Additionally, additive manufacturing can reduce the overall manufacturing costs associated with generating these complex articles compared to molding techniques generally used.

### BRIEF DESCRIPTION

In one embodiment, a method of binder jet printing a metal part includes depositing a layer of a metal powder on a working surface of a binder jet printer and selectively printing a binder solution having a reversible binder into the layer of metal powder in a pattern to generate a printed layer. The pattern is representative of a structure of a layer of the metal part. The method also includes curing the reversible binder in the printed layer to generate a layer of a green body metal part and heating the green body metal part above a first temperature to remove a substantial portion of the reversible binder and generate a brown body metal part. The brown body metal part is intended to denote a metal part stage that is between the green body metal part (e.g., a metal part stage before debinding) and a consolidated metal part (e.g., a metal part stage after a sintering process). The reversible binder is thermally decomposed to generate oligomers that remain within and strengthen the brown body metal part. The method further includes heating the brown body metal part above a second temperature to remove the oligomers and sinter the metal powder to generate the metal part. The metal part is substantially free of char residue.

In a second embodiment, a metal part manufactured via a binder jet printing process including the steps of depositing a layer of a metal powder on a working surface of a binder jet printer and selectively printing a binder solution that may be used for binder jetting into the layer of metal powder in a pattern representative of a structure of a layer of the metal part to generate a printed layer. The binder solution includes a reversible binder. The process also includes curing the printed layer to generate a green body metal part having the reversible binder and heating the green body metal part above a first temperature to remove a substantial portion of the reversible binder and to generate a brown body metal part having oligomers. The reversible binder is thermally decomposed to generate the oligomers. The process further includes heating the brown body metal part above a second temperature to remove the oligomers and sinter the metal powder to generate the metal part. The metal part is substantially free of char residue.

In a third embodiment, a binder solution that may be for use in binder jet printing, includes a reversible binder having a polymer that may thermally decompose into oligomers at a temperature range between approximately 75 degrees Celsius (° C.) and approximately 500° C. The oligomers may thermally decompose into volatile molecules that leave no char residue at a temperature range of between approximately 500° C. and approximately 1000° C.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a flow diagram of an embodiment of a method of manufacturing a metal part via a binder jet printing process that uses a reversible thermoset or thermoplastic binder;

FIG. 2 is a schematic diagram of an embodiment of a layer of material from which the metal part is printed resulting from the acts of the method of FIG. 1;

FIG. 3 is a block diagram of an embodiment of a binder jet printer used to print the metal part in accordance with the method of FIG. 1;

FIG. 4. is a cross-sectional view of an embodiment of a printed layer having particles of the material coated with the reversible binder in accordance with the method of FIG. 1;

FIG. 5 is a top view of an embodiment of the printed layer of FIG. 4 having the reversible binder selectively deposited in a pattern representative of a structure of the metal part in accordance with the method of FIG. 1;

FIG. 6 is a plot of an embodiment illustrating a decomposition of reversible binders shown as weight percent (wt %) of the reversible binder remaining as a function of temperature; and

FIG. 7 is a micrograph of an embodiment of a solid metal part printed in accordance with the method of FIG. 1.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

There are several techniques for manufacturing articles, such as metal parts used in a variety of machinery. For example, molding techniques such as sand molding, cast molding, and/or injection molding, among others, may be used to manufacture the metal parts for machinery applications. As noted above, other techniques that may be used to manufacture metal parts include additive manufacturing. For example, additive manufacturing techniques that may be used to manufacture articles include, but are not limited to, laser melting, laser sintering, and binder jetting. Additive manufacturing may be advantageous for fabricating metal parts compared to molding techniques due, in part, to the flexibility of materials that may be used, the ability to manufacture complex articles, and low manufacturing costs.

Unlike laser melting and laser sintering additive manufacturing techniques, which heat the material to consolidate and build layers of the material to form a metal part, binder jetting uses a chemical binder to bond particles of the material into layers that form a green body of the metal part. The green body may be further processed (e.g., sintered) to consolidate the layers and form the part. Bonding layers of material using a chemical binder has been used in sand molding techniques to bond sand particles and form a sand mold that can be used to fabricate other parts. Similar to sand molding, in binder jet printing, the chemical binder is successively deposited into layers of metal powder to print the metal part. For example, the chemical binder (e.g., a polymeric adhesive) may be selectively deposited onto a metal powder bed in a pattern representative of a layer of the part being printed. Each printed layer may be cured (e.g., via heat, light, moisture, solvent evaporation, etc.) after printing to bond the metal particles of each layer together to form the green body metal part. After the green body metal part is fully formed, the chemical binder is removed during post-printing processes (e.g., debinding and sintering). It may be appreciated that such debinding and sintering steps are not part of sand molding processes, in which the chemical binder remains an integral part of the sand mold, even as the sand mold is subsequently used to form a molded metal part. However, in binder jet 3D printing, the chemical binder is an integral part of the green body metal part (e.g., the chemical binder is disposed within and in between each layer of the printed metal part), and is subsequently removed during debinding and/or sintering to form a completed 3D printed metal part. It may also be noted that binder jet printing enables the manufacture of metal parts having complex, 3D geometries that are impossible or impractical to manufacture using a sand molding manufacturing process.

However, in post-printing processes of a binder jet manufacturing method, the chemical binder may decompose in a manner that forms char residue within (e.g., between the particles of the metal powder) the metal part. For example, in binder jet 3D printing, the printed (green body) metal part may undergo a sintering process to consolidate particles of metal powder within the printed layers and increase the density of the printed metal part, thereby forming a substantially solid, consolidated metal part having sufficient strength for use in machinery. During sintering, the printed metal part is exposed to temperatures that may be near (e.g., within about 70% of) the absolute temperature melting point of the metal powder used to fabricate the printed article. Therefore, sintering temperatures may be in excess of 1000 degrees Celsius (° C.), depending on the metal powder used to fabricate the printed metal part. At the sintering temperatures, the chemical binder, which is generally an organic compound, can incompletely decompose and form a char residue that may be consolidated along with the layers in the consolidated metal part. Additionally, the sintering conditions may cause oxidation of the metal in the metal part, resulting in metal oxide formation. The char residue may affect certain properties of the article (e.g., microstructure, mechanical properties) that may result in undesirable effects (e.g., stress fractures, corrosion, etc.) when the article is in use. As used herein, the char residue is intended to denote a carbonaceous material formed from incomplete decomposition of the binder, oxygen-containing species bound to the binder, oxygen-containing species bound to the metal part (e.g., metal oxide), or combinations thereof.

Accordingly, to mitigate formation of char residue during sintering, a binder removal step is performed to remove a substantial portion of the chemical binder to form a brown body metal part before sintering. However, it is presently recognized that the brown body metal part should have sufficient handling strength (brown handling strength) to maintain the integrity of the structure until it undergoes sintering to consolidate the layers. Therefore, it is presently recognized that it is desirable for a portion of the chemical binder to remain in the brown body metal part to provide the desired brown strength.

However, chemical binders generally available for binder jet 3D printing tend to produce char residue within the consolidated metal part. For example, a process for removing the chemical binders from the brown body may be performed in an oxygen (O₂) containing environment. The O₂ may drive complete decomposition of the chemical binder to carbon dioxide (CO₂) and water (H₂O), among other decomposition by-products. However, these debinding conditions (e.g., O₂-containing environment) may result in formation of metal oxides in the consolidated metal part. Accordingly, certain properties (e.g., mechanical properties) of the consolidated metal part may be undesirable and the part may be unsuitable for use in the desired machinery. As such, there is a need to develop chemical binders that can be used for binder jet 3D printing that provide sufficient bond strength to maintain the integrity of the brown body metal part before sintering, and that are cleanly removed during sintering such that the consolidated metal part is substantially free of char and any other undesirable decomposition products of the chemical binder. In addition, to clean removal of the chemical binders, the conditions used to remove the chemical binders may decrease formation of metal oxides compared to O₂-containing conditions generally used for chemical binder removal. Disclosed herein are chemical binders (i.e., reversible binders) that may be used for binder jet 3D printing, that are sufficiently thermally stable to partially survive a first (debinding) heat treatment to maintain the structure of the brown body metal part, and sufficiently thermally unstable to be readily and cleanly removed from the brown body metal part during a second (sintering) heat treatment to form the consolidated metal part having minimal to no residual metal oxide content.

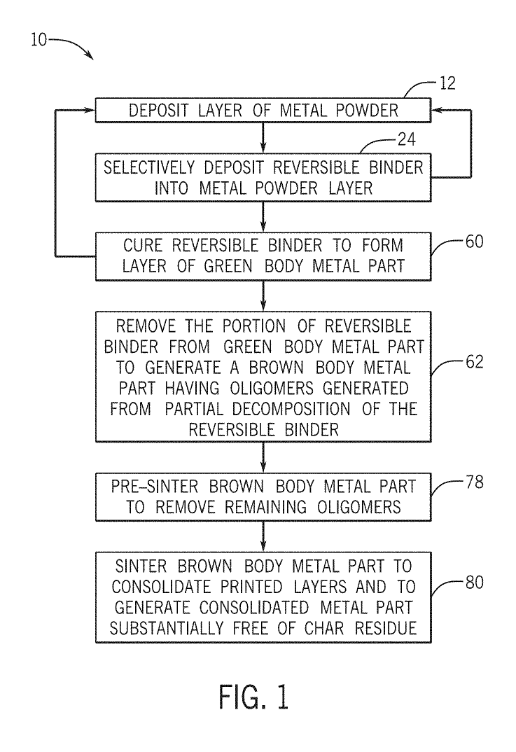

With the foregoing in mind, FIG. 1 is a block diagram depicting a method 10 for manufacturing an article via binder jet 3D printing using a reversible binder. As defined herein, the reversible binder is intended to denote a thermoplastic or thermoset polymer that, during decomposition, is broken down into oligomers and other molecules that are similar or identical to the monomers used to derive the polymer. The reversible binder may be polymerized via radical chain reactions to bond particles and layers of a metal powder used to print the article. Additionally, while the smaller molecules generated from decomposition of the reversible binder during debinding may volatilize and be removed from the brown body metal part, it is presently recognized that, when the debinding conditions are properly controlled, the oligomers remain within and impart desirable handling strength to the brown body metal part. These oligomers in the brown body metal part can then be removed in a pre-sintering process, which cleanly decomposes and removes the oligomers into smaller molecules (e.g., molecules similar or identical to the monomers used to derive the reversible binder) while preparing the brown body metal part for sintering. In this way, the reversible binder is removed from the printed metal part and a consolidated metal part suitable for use in machinery is produced that is substantially free of char residue associated with the decomposition of the chemical binders used to manufacture the printed metal part. Additionally, the conditions by which the reversible binder undergoes decomposition in inert atmospheres, mitigates formation of metal oxides on the consolidated metal part resulting from a reaction between the metal of the green body and water (H₂O) and/or oxygen (O₂) during debinding.

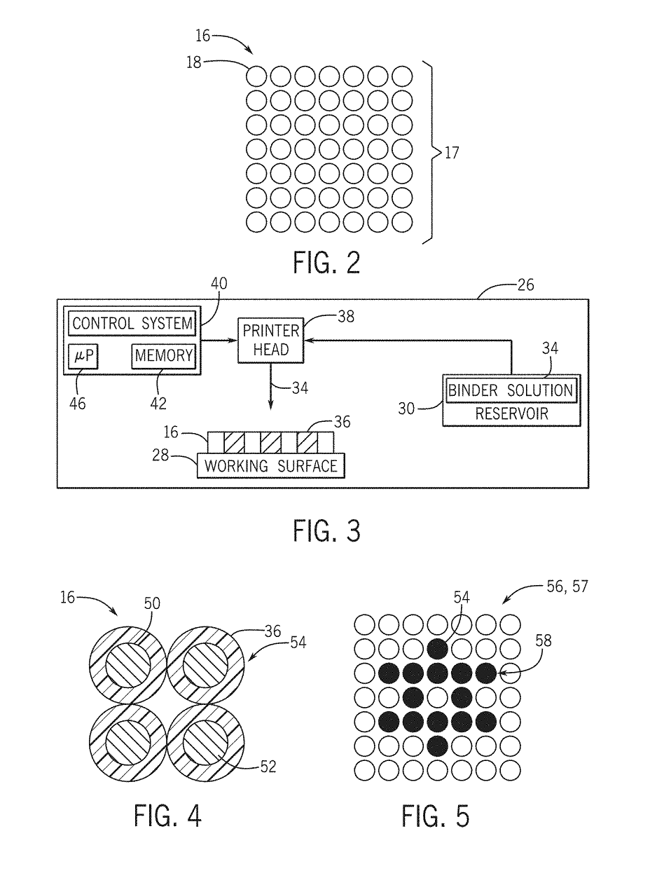

To facilitate discussion of aspects of the method 10 illustrated in FIG. 1, reference is made to FIGS. 2-5, which generally correspond to certain steps of the illustrated method 10. The method 10 of FIG. 1 begins with depositing a layer of a metal powder that is used to manufacture an article of interest (block 12). For example, FIG. 2 is a cross-sectional view of a layer 16 of a metal powder 18 (e.g., a powder bed) on a working surface of a binder jet printer. In certain embodiment, the layer 16 may have a thickness 17 of between approximately 10 microns (μm) and approximately 200 μm. However, in other embodiments, the thickness 17 of the layer 16 may be any suitable value.

The metal part to be printed may include a variety of metal parts having complex, 3D shapes, such as, but not limited to, fuel tips, fuel nozzles, shrouds, micro mixers, turbine blades, or any other suitable metal part. Therefore, the material 18 used to print the article may vary depending on the type of article and the end use of the article (e.g., gas turbine engines, gasification systems, etc.). By way of non-limiting example, the metal powder 18 may include: nickel alloys (e.g., Inconel 625, Inconel 718, Rene'108, Rene'80, Rene'142, Rene'195, and Rene'M2, Marm-247); cobalt alloys (e.g., Hans 188 and L605); cobalt-chromium alloys, cast alloys: (e.g., X40, X45, and FSX414), titanium alloys, aluminum-based materials, tungsten, stainless steel, or any other suitable material and combinations thereof. In certain embodiments, the metal powder 18 may have particles having a particle size distribution that is between approximately 1 micron (μm) and 75 μm. However, the metal powder 18 may have any other suitable particle size distribution.

Following deposition of the layer of metal powder 16, the method 10 continues with selectively depositing a reversible binder into portions of the layer 16 to according to a pattern (block 24). For example, the reversible binder may be selectively printed into the layer of metal powder 16 using a print head that is operated by a controller based on a CAD design that includes representation of the layer of the metal part being printed.

For example, FIG. 3 is a block diagram of a binder jet printer 26 that may be used to selectively deposit the reversible binder into the portion of the layer 16, according to the acts of block 24 (FIG. 1). In the illustrated embodiment, the binder jet printer 26 includes a working surface 28 that supports the layer of metal powder 16, a reservoir 30 that stores a binder solution 34 having a reversible binder 36, and a printer head 38 that is fluidly coupled to the reservoir 30. The printer head 38 selectively deposits the binder solution 34 into the layer of metal powder 16 to print the reversible binder 36 onto and into the layer 16 in a pattern that is representative of the layer of the metal part being printed. The illustrated binder jet printer 26 includes a control system 40 for controlling operation of the binder jet printer 26. The control system 40 may include a distributed control system (DCS) or any computer-based workstation that is fully or partially automated. For example, the control system 40 can be any device employing a general purpose computer or an application-specific device, which may generally include memory circuitry 42 storing one or more instructions for controlling operation of the binder jet printer 26. The memory 42 may store CAD designs representative of a structure of the article being printed. The processor may include one or more processing devices (e.g., microprocessor 46), and the memory circuitry 36 may include one or more tangible, non-transitory, machine-readable media collectively storing instructions executable by the processor to control actions described herein.

As discussed above, the binder solution is selectively deposited into the layer of metal powder 16 in a pattern representative of the structure of the metal part being printed. FIG. 4 is a cross-sectional view of the layer of metal powder 16 after deposition of the reversible binder 36. As illustrated, the reversible binder 36 coats an outer surface 50 of metal powder particles 52, thereby generating binder-coated particles 54. The reversible binder 36 bonds the binder-coated particles 54 according to the pattern printed into the layer of metal powder 16 to form a layer of the green body metal part after curing. For example, FIG. 5 is a top view of a printed layer 56 of a green body metal part 57 having the binder-coated particles 54 bonded to one another in a pattern 58 that is representative of the layer of the metal part being printed.

Returning to FIG. 1, the method 10 may repeat the acts of blocks 12 and 24 to continue building up the metal part in a layer-by-layer manner until a desired number of layers have been printed to generate the green body metal part. The reversible binder 36 bonds each successive layer 56 and provides a certain degree of strength (e.g., green strength) to the printed article such that the integrity of the structure of the printed (green body) metal part is not affected during post-printing processes (e.g., debinding, sintering, etc.). That is, the green strength provided by the reversible binder 36 maintains bonding between the particles of metal powder within the layers 56 and blocks (e.g., resists, prevents) delamination of the layers 56 during handling and post-printing processing of the green body metal part.

As discussed above, the reversible binder disclosed herein facilitates manufacturing of a 3D printed article that is substantially free of char residue that may be formed during sintering of the 3D printed article. Accordingly, the reversible binder 36 may be selected from a class of thermoplastic or thermoset polymers that generally decompose into oligomers that enable good brown handling strength, and that can be cleanly and readily removed during sintering, to generate a consolidated metal part that is substantially free of the reversible binder 36 and decomposition products (e.g., char) that may be generated during post-printing processes conditions.

For example, as discussed in further detail below, certain post-printing processing conditions may decompose the reversible binder 36 into oligomers that continue to bond the layers 56 of the brown body metal part such that the integrity of the structure of the brown body metal part is not affected. The oligomers may be further broken down in a separate post-printing process into smaller molecules (e.g., decomposition products that are similar or identical to the monomers used to derive the reversible binder 36). These decomposition products may be gaseous at room temperature or may have a boiling point that facilitates removal of the decomposition products under the conditions associated with the post-printing processes, as discussed in further detail below. Accordingly, the article resulting from the printing and post-printing processes (i.e., the finished or consolidated metal part) may be substantially free of both the reversible binder 36 and char residue (e.g., carbonaceous material from incomplete decomposition of the reversible binder 36, oxygen-containing species bound to the reversible binder 36, oxygen containing species bound to the metal part (e.g., metal oxides), and combinations thereof). Therefore, the properties (e.g., microstructure, mechanical properties, etc.) of the resultant metal part may be similar or equal to the properties of the metal powder 18 used to generate the resultant metal part.

The reversible binder 36 in accordance with the present disclosure may include polymers derived from unsaturated monomers. For example, the reversible binder 36 may one or more polymers have the following formulas: (CH₂CHR)ₙ, where R=—H, —OH, phenyl, alkyl, aryl. The reversible binder 36 may also include one or more mono-functional acrylic polymers having the formula (CH₂—CR²COOR¹)ₙ, where R¹=alkyl, aryl, and R²=H or CH₃, di-acrylic polymers having the formula [(CH₂—CR²COO)₂—R³]ₙ, where R²=H or CH₃ and R³=a divalent hydrocarbon radical; tri-acrylic polymers having the following formula [(CH₂CR¹COO)₃—R⁴]ₙ, where R¹=H or CH₃ and R⁴=a trivalent hydrocarbon radical and/or poly(alkylene carbonates) including co-polymeric alkylene carbonates, such as poly(ethylene-cyclohexene carbonate) and those having the following formulas:

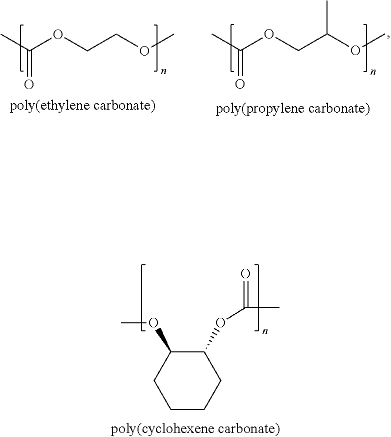

By way of non-limiting example, the reversible binder 36 may include poly(methylmethacrylate) (PMMA), polystyrene (PS), poly(vinyl alcohol) (PVA); poly(alkylene carbonates), for example QPAC® 25, 40, 100, and 130 from Empower Materials, and polymers derived from hexanediol diacrylate (HDDA), trimethylolpropane triacrylate (TMPTA, for example, SR351 from Sartomer), and diethylene glycol diacrylate (DGD).

As discussed above with reference to FIG. 3, the printer head 38 receives the binder solution 34 (e.g., ink) having the reversible binder 36 and prints the reversible binder 36 into the layer of metal powder 16. Accordingly, the binder solution 34 may have certain properties that facilitate binder jet printing via the printer head 38. The binder solution 34 may include additives that may facilitate deposition of the reversible binder 26 into the layer 16. For example, the binder solution 34 may include one or more additives such as viscosity modifiers, dispersants, stabilizers, surfactants (e.g., surface active agents) or any other suitable additive that may facilitate jettability of the binder solution 34 and deposition of the reversible binder 36 into the layer of metal powder 16. The surfactants may be ionic (e.g., zwitterionic, cationic, anionic) or non-ionic depending on the properties of the reversible binder 36 and/or the metal powder 18. By way of non-limiting example, the surfactant may be polypropoxy diethyl methylammonium chloride (e.g., VARIQUAT® CC-42NS), in certain embodiments.

The one or more additives may improve the wettability of the material 18 to facilitate coating the particles of the metal powder 52 with the reversible binder 36. The one or more additives may also change (e.g., modify) the surface tension of the binder solution to facilitate jettability of the binder solution. For example, in certain embodiments, the binder solution is generally considered jettable if the Ohnesorge number (e.g., the ratio of viscous forces to inertial and surface tension forces) is between approximately 0.1 and approximately 1.

In certain embodiments, the one or more additives may also include a solvent that dissolves the reversible binder 36. The solvent may be aqueous or non-aqueous, depending on the selected reversible binder 36 and other additives that may be in the binder solution 34. The solvent is generally non-reactive (e.g., inert) such that it does not react with the metal powder 18, the reversible binder 36, or any other additives that may be in the binder solution 34. Additionally, the solvent should readily evaporate after selective deposition of the reversible binder 36 into the layer of metal powder 16 to facilitate bonding of the binder-coated particles 54 and the printed layers 56. Example solvents that may be used in the binder solution include, but are not limited to, water, methylene chloride (CH₂Cl₂), chloroform (CHCl₃), toluene, xylenes, mesitylene, anisole, 2-methoxy ethanol, butanol, diethylene glycol, tetrahydrofuran (THF), methyl ethyl ketone (MEK), trichloroethylene (TCE), or any other suitable solvent.

The binder solution 34 may include the reversible binder 36, one or more monomers used to derive the reversible binder 36, or both. For example, in certain embodiments, the reversible binder 36 is polymerized before selective deposition into the layer of metal powder 16, according to the acts of block 24 of FIG. 1. Therefore, in certain embodiments, the reversible binder 36 in the binder solution 34 may be in the form of a pre-formed, dissolved polymer. The reversible binder 36 may be solubilized in a suitable solvent to facilitate jettability and deposition into the layer of metal powder 16. Following deposition of the binder solution 34 into the layer of metal powder 16, the solvent may evaporate and the reversible binder 36 may coalesce and bond the binder-coated particles 54 and the printed layers 56 to form the green body metal part.

In other embodiments, the reversible binder 36 is polymerized after depositing the binder solution 34 into the layer of metal powder 16. That is, the reversible binder 36 may be polymerized in situ. For such embodiments, the binder solution 34 may include one or more polymerizable monomers (e.g., reactive monomers) that react to form the reversible binder 36. In one embodiment, the binder solution 34 includes the one or more polymerizable monomers and a suitable solvent. In other embodiments, the binder solution 34 does not include a solvent. Rather, the binder solution 34 may be a neat liquid of the one or more polymerizable monomers. Once the binder solution 34 is deposited onto the layer 16, the one or more polymerizable monomers may be polymerized to form the reversible binder 36 in situ within the layer of metal powder 16 to form the printed layer 56 of the green body metal part. In certain embodiments, the binder solution 34 may include initiators such as, for example, azobis (isobutyronitrile) (AIBN), to facilitate in situ polymerization of the one or more polymerizable monomers in the layer of metal powder 16.

By way of non-limiting example, in certain embodiments, the binder solution 34 may include between approximately 0.5 weight percent (wt %) and approximately 30 wt % of the polymerized reversible binder 36 or the polymerizable monomers used to derive the reversible binder 36 in situ. In one embodiment, the binder solution 34 includes between approximately 3 wt % and approximately 7 wt % of the polymer or the polymerizable monomers. Additionally, the binder solution 34 may include suitable viscosity modifiers to enable a viscosity of the binder solution 34 that is between approximately 2 centipoise (cP) and approximately 200 cP. For example, depending on the viscosity of the mixture of the solvent and polymer/polymerizable monomer solution or the neat polymerizable monomer solution, the binder solution 34 may have between approximately 0.1 wt % and 15 wt % of a viscosity modifier, such that the viscosity of the binder solution is within the desired range for efficient and effective jettability.

Following deposition of the layer 16 and printing of the reversible binder 36, as set forth in blocks 12 and 24 of FIG. 1, the method 10 continues with curing the reversible binder to form a layer of the green body metal part (block 60). For example, as discussed above, the binder solution 36 may be a mixture of the reversible binder 26 (e.g., polymer) and a solvent. While a portion of the solvent in the binder solution 36 may be evaporated during deposition (e.g., printing) of the reversible binder 36, a certain amount of the solvent may remain within the layer of metal powder 16. Therefore, in certain embodiments, the green body metal part may be thermally cured (in a subsequent, post-print step) at a temperature that is suitable for evaporating the solvent remaining in the printed layer 56 and allowing efficient bonding of the printed layers 56 of the green body metal part.

In certain embodiments, the green body metal part may be cured to allow polymerization of the polymerizable monomers in the binder solution 34 to yield the reversible binder 36. For example, as discussed above, the reversible binder 36 may be polymerized in situ after printing the binder solution 34 into the layer of metal powder 16. Following deposition of the binder solution 34, the one or more polymerizable monomers in the binder solution 34 may be cured to polymerize the one or more monomers and form the printed layer 56 of the green body metal part. For example, the printed layer 56 may be exposed to heat, moisture, light, or any other suitable curing method that polymerizes the one or more polymerizable monomers in the binder solution 34 to form the reversible binder 36 in the printed layer 56 before the next layer of metal powder (block 12) is deposited on top of the printed layer 56. In certain embodiments, the binder solution 34 may include a radical initiator (e.g., AIBN) to facilitate polymerization of the one or more polymerizable monomers. In one embodiment, the one or more polymerizable monomers selectively deposited into the printed layer 56 may be cured immediately after forming the printed layer 56. That is, the method 10 may repeat the acts of blocks 12 and 24 of the method 10 after curing the one or more polymerizable monomers on each printed layer 56. In other embodiments, the one or more polymerizable monomers on the printed layer 56 may be cured after a desired number of printed layers 56 have been formed. Excess material 18 (e.g., the material 18 that is not bonded by the reversible binder 36) may be removed after curing to prepare the green body for post-printing processing. After curing, the green body may undergo a drying step to remove any solvent and/or other volatile materials that may remain in the green body metal part. For example, the green body may be dried in a vacuum, under an inert atmosphere (e.g., nitrogen (N₂), argon (Ar)), or air.

As discussed above, the reversible binder used to form the green body metal part in binder jetting applications may be removed in a manner that mitigates both formation of char residue and metal oxide formation during post-printing processes. Accordingly, the method 10 includes removing (e.g., debinding) a portion of the reversible binder 36 from the green body metal part to generate a brown body metal part (block 62). As discussed above, the binders used in binder jetting applications provide strength (e.g., green strength) to the printed article. Therefore, as mentioned, it is presently recognized that it is desirable to remove only a portion (i.e., not all) of the reversible binder during debinding of the green body metal part to improve the handling strength of the resulting brown body metal part before sintering.

However, as mentioned, certain binders used in binder jet 3D printing may leave undesirable char residue during post-printing heat treatments, which may result in undesirable properties in the metal part. It is now recognized that by using the reversible binder 36, the printed article may have a desirable strength after partial removal of the reversible binder 36 during debinding, and may result in a consolidated article that is substantially free of char residue after sintering. In this way, certain properties of the consolidated metal part may be similar or identical to the properties of the metal powder 18 used to print the article.

During the partial removal of the reversible binder 36 during debinding, the green body metal part may be heated to break down the reversible binder 36 into oligomers that are smaller and have a lower molecular weight compared to the reversible binder 36, but that are still too large to volatilize under the debinding conditions. For example, the green body metal part may be heated to a temperature that is approximately 500° C. or less, such as between approximately 250° C. and approximately 450° C., during the debinding step of block 62. The conditions to which the green body metal part is exposed during debinding decomposes the reversible binder 36 into the oligomers and generates the brown body metal part having a substantial portion (e.g., approximately 95%, approximately 96%, approximately 97%, approximately 98%) of the reversible binder 36 removed. The oligomers that remain in the brown body metal part after debinding may continue to bond the printed layers in the brown body metal part and provide a brown strength that maintains the structure of the brown body metal part during handling.

In certain embodiments, between approximately 98% and approximately 99.95% of the reversible binder 36 may be removed during debinding by partial decomposition of the reversible binder 36. Many of the small molecules that form during the partial decomposition of the reversible binder may be gaseous at room temperature or at the debinding temperature. The portion of the oligomers that remain in the brown body metal part after debinding continue to bond the layers of metal powder of the brown body metal part and enable a suitable amount of brown strength. In one embodiment, the portion of the oligomers that remain in the brown body is between approximately 0.05% and approximately 2%. In other embodiments, the portion of the oligomers that remain in the brown body is between approximately 0.1% and approximately 1%.

In certain embodiments, debinding of the reversible binder 36 may include heating the green body metal part to a desired temperature (e.g., between approximately 250° C. and approximately 450° C.) in an oxygen-free environment (e.g., in a vacuum chamber). It is presently recognized that debinding the reversible binder 36 in an oxygen-free environment may mitigate oxidation of certain metal powders 18. For example, debinding may be performed under nitrogen (N₂), argon (Ar), or another substantially inert gas. However, in certain embodiments, the debinding may be performed in air. In embodiments where the debinding occurs in air, it may be desirable to maintain the debinding temperature below 450° C. to mitigate oxidation of the metal powder 18.

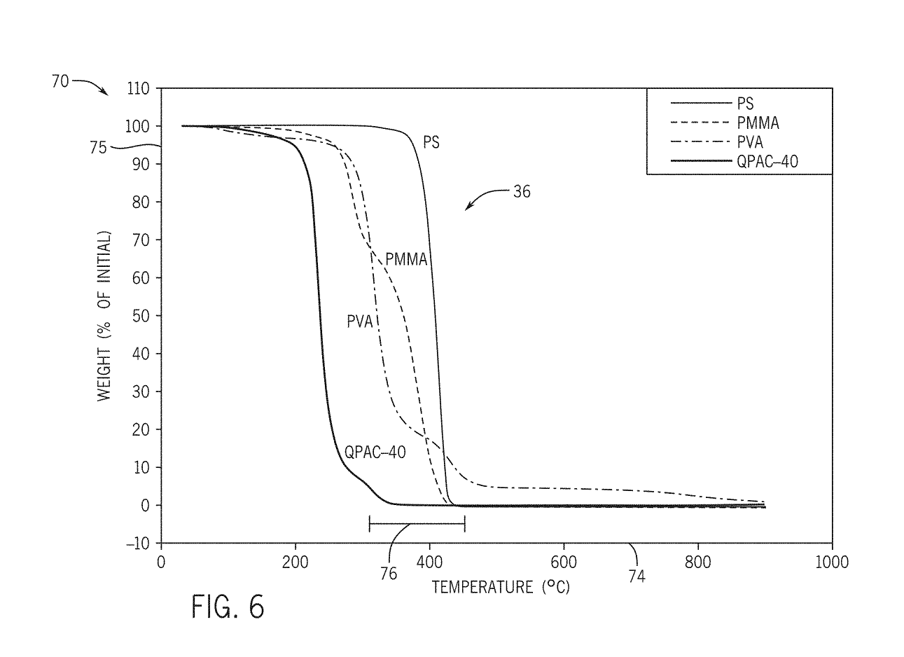

FIG. 6 is a plot 70 of a thermal gravimetric analysis (TGA) of an embodiment of the disclosed reversible binders (e.g., the reversible binder 36) illustrating a change in weight percentage 72 of the reversible binders 36 as a function of debinding temperature 74, conducted under a flowing N₂ atmosphere up to 900° C. As shown in FIG. 6, the weight percentage 72 of the reversible binders 36 decreases as the temperature 74 increases, which is indicative that the reversible binder 36 is generally decomposing with increased heating. However, it may be noted that a number of the reversible binders represented in FIG. 6 include a central region 76 of the graph (e.g., between approximately 300° C. and 450° C., between approximately 350° C. and 400° C.) in which the rate of reversible binder weight loss with increasing temperature is partially detained, and that full decomposition of the reversible binder does not continue until after the upper temperature limit of this region is exceeded. As such, it is presently believed this region corresponds to the thermal decomposition of the reversible binder into relatively stable oligomers that do not decompose or volatilize under at the debinding temperature. Therefore, it is believed that when a green body metal part is debinded at a temperature that is generally within such a region the debinding results on only the partial removal of the reversible binder, and results in the formation of oligomers that remain within the brown body metal part until the higher temperature pre-sintering step discussed below.

Following debinding of the reversible binder 26, as set forth in block 62, the method 10 of FIG. 1 continues with pre-sintering the brown body metal part to remove the oligomers remaining in the brown body metal from the partial decomposition of the reversible binder (block 78). For example, during pre-sintering, the brown body metal part may be heated to pre-sintering temperatures that are between approximately 500° C. and approximately 800° C. The heat applied to the brown body metal part during pre-sintering decomposes the remaining oligomers into small molecules that quickly volatilize and escape from the brown body metal part. The oligomers decompose cleanly into the smaller molecules, which may evaporate through the porous structure of the brown body, leaving substantially no residue. As such, when the brown body metal part is sintered, the resulting consolidated metal part may be substantially free of char. Accordingly, the consolidated metal part may have properties similar to those of the metal powder 18 used to print the metal part.

Finally, the method 10 illustrated in FIG. 1 concludes with sintering the brown body metal part to consolidate the particles of metal powder without generating a char residue (block 80). During sintering, the brown body metal part may be exposed to a concentrated source of energy (e.g., a laser, electron beam, or any other suitable energy source) that heats the brown body metal part and consolidates the printed layers 56 of the brown body to form a substantially solid metal part (e.g., the consolidated metal part) having a density that is greater than the density of the brown body metal part. Sintering imparts strength and integrity to the brown body metal part such that the consolidated metal part is suitable for use in machinery. Sintering temperatures may be in excess of 1000° C., depending on the metal powder 18 used to print the part. For example, in certain embodiments, the sintering temperature may be between approximately 1200° C. and approximately 1300° C. Therefore, any organic compounds, such as the binders generally used in binder jetting, that may be present in the brown body metal part may form char residue during sintering.

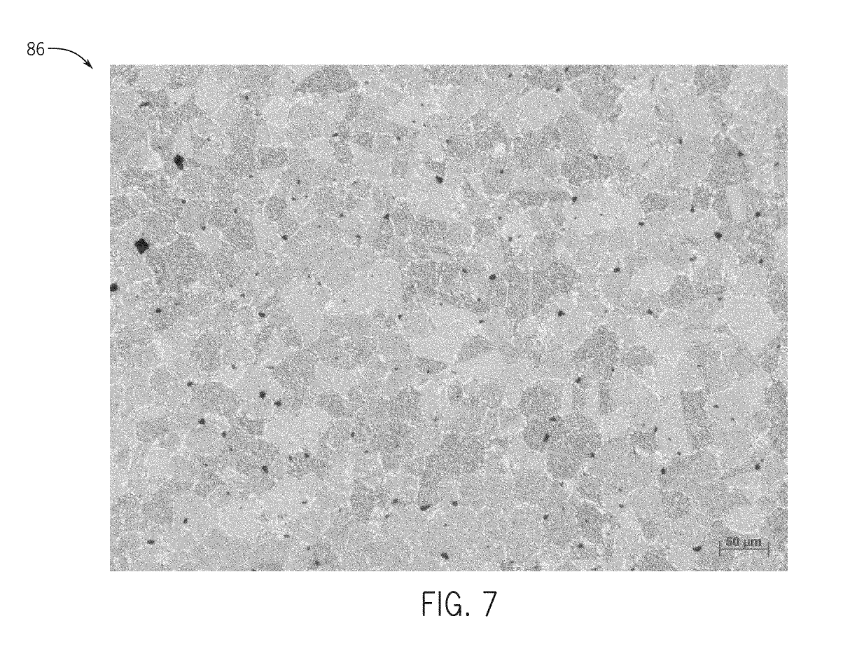

FIG. 7 illustrates an etched micrograph of a solid metal part 86 generated using the reversible binder 36 in accordance with the method 10. For example, the solid metal part 86 was printed using Rene'108 as the metal powder 18 and polymethylmethacrylate (PMMA) as the reversible binder 36 and subjected to debinding (e.g., block 62), and sintered (e.g., block 80), which resulted in a density of approximately 99.1%. Therefore, it is now recognized that using the reversible binder 36 results in solid metal parts having a desirable microstructure. In certain embodiments, a porosity of the solid metal part 86 may be reduced. For example, the solid metal part 86 may undergo a hot isostatic pressing (HIP) step. The hot isostatic pressing of the solid metal part 86 may yield a dense metal part having a density that is between approximately 93% and approximately 99%.

As discussed above, the char may affect certain characteristics of the consolidated article (e.g., microstructure and/or mechanical properties) which may affect the performance of the consolidated metal part when used in machinery. However, it is now recognized that, by using the reversible binder 36 and the post-processing steps disclosed herein, the consolidated metal part may be substantially free of char residue. Therefore, the properties of the consolidated metal part may be similar to the properties of the metal powder 18, and may be comparable to properties of metal parts manufactured via molding techniques. The consolidated metal part manufactured via binder jet 3D printing using the reversible binder 36 disclosed herein may have a carbon content and an oxygen content that is equal to or less than a carbon content and oxygen content of the metal powder 18 used to print the metal part.

State of the art chemical binders used for 3-D binder jet metal printing generally produce metal articles having char residues that yield carbon (C) and oxygen (O) (e.g., metal oxides or oxygen-containing binder decomposition products) content that is greater than the C and O levels of the metal powder used to print the metal part. While certain post-printing processes may decrease the C content of the metal part to levels comparable to or below that of the metal powder, these processes generally increase the Ocontent to levels above that of the metal powder. Similarly, the C content of the metal part may be above desirable levels when O₂ levels in the debinding atmosphere are below a desired range. For example, when an amount of O₂ in the atmosphere is not sufficient to decompose the state of the art binders. However, the reversible binders disclosed herein, surprisingly and unexpectedly, result in C and O content that is less than the C and O content of the metal powder under suitable post-printing processing conditions.

Tables 1 and 2 show the carbon (C) and oxygen (O) content of consolidated metal parts manufactured using the reversible binder 36. For example, as shown in Tables 1 and 2, consolidated metal parts fabricated with certain reversible binders have a C and O content that is substantially less than the C and O content of the metal powder 18. For example, as shown in Table 1, consolidated metal parts made using Inconel 625 as the metal powder 18 and 5 wt % polymethylmethacrylate (PMMA) in 2-methoxyethanol or polystyrene in toluene as the binder solution 34 yield a consolidated metal part having a C and O content that is less than the C and O content of the Inconel 625 metal powder. Similarly, consolidated metal parts formed using Rene'108 as the metal powder 18 and 5 wt % PMMA in 2-methoxy ethanol or 7 wt % PMMA in 2-methoxyethanol with and without polypropoxy diethyl methylammonium chloride (e.g, VARIQUAT CC-42NS) as the binder solution 34 also yield a C and O content that is less than the C and O content of the Rene'108 metal powder. The data represented in Tables 1 and 2 was obtained via combustion analysis of binder jet 3D printed metal part samples using a LECO CS 844 Carbon/Sulfur Analyzer for carbon quantification and LECO ONH 836 Oxygen/Nitrogen/Hydrogen Analyzer for oxygen quantification.

TABLE 1
Elemental analysis of Inconel 625 articles
produced using various reversible binders

| | | | Maximum | | |
|---|---|---|---|---|---|
| | Binder | | Process | | |
| | Formu- | Process | Temp. | C | O |
| Binder | lation | Condition | (° C.) | (ppmw) | (ppmw) |
| none | N/A | As-received | N/A | 172 | 370 |
| | | raw metal | | | |
| | | powder | | | |
| PMMA | 5 wt % in 2- | 7.4% O₂ debind | 400 | 176 | 120 |
| | methoxy- | Vac. debind | 350 | 322 | 430 |
| | ethanol | Air debind | 350 | 170 | 949 |
| | | N₂ debind | 400 | 236 | 300 |
| | | N₂ debind/ | 1250 | 68 | 90 |
| | | vac. sintered | | | |
| PMMA | 7 wt % in 2- | Vac. debind | 300 | 122 | 890 |
| | methoxy- | Vac. debind/ | 1285 | 37 | 570 |
| | ethanol | vac. sintered | | | |
| PMMA | 7 wt % in 2- | N₂ debind | 300 | 1517 | 1080 |
| | methoxy- | N₂ debind/ | 1285 | 57 | 620 |
| | ethanol | vac. sintered | | | |
| PMMA | 7 wt % in 2- | Air debind | 350 | 170 | 960 |
| | methoxy- | Air debind/ | 1285 | 20 | 1060 |
| | ethanol | vac. sintered | | | |
| Poly- | 10 wt % in | 7.4% O₂ debind | 400 | 172 | 1070 |
| styrene | toluene | 7.4% O₂ debind/ | 1270 | 13 | 949 |
| | | vac. sintered | | | |
| Poly- | 10 wt % in | N₂ debind | 400 | 10800 | 490 |
| styrene | toluene | N₂ debind/ | 1270 | 24 | 140 |
| | | vac. sintered | | | |
| Poly- | 10 wt % in | Air debind | 350 | 177 | 1160 |
| styrene | toluene | Air debind/ | 1270 | 13 | 1020 |
| | | Vac. sintered | | | |
| QPAC- | 10 wt % in | 7.4% O₂ debind | 400 | 178 | 900 |
| 40 | MEK | Air debind | 350 | 172 | 1280 |
| QPAC- | 10 wt % in | N₂ debind | 400 | 270 | 317 |
| 40 | MEK | N₂ debind/ | 1270 | 71 | 106 |
| | | Vac. sintered | | | |
| PVA | 5 wt % in | Vac. debind | 400 | 660 | 380 |
| | water | | | | |
| | 5 wt % in | Vac. debind/ | 1270 | 377 | 70 |
| | water | vac. sintered | | | |
| PVA | 5 wt % in | Vac. debind | 400 | 620 | 370 |
| | water, w/ | Vac. debind/ | 1270 | 278 | 70 |
| | 0.35 wt % | vac. sintered | | | |
| | Variquat | | | | |
| | CC-42NS | | | | |

TABLE 2
Elemental analysis of Rene' 108 articles
produced using various reversible binders

| | | | Maximum | | |
|---|---|---|---|---|---|
| | Binder | | Process | | |
| | Formu- | Process | Temp. | C | O |
| Binder | lation | Condition | (° C.) | (ppmw) | (ppmw) |
| none | N/A | As-received | N/A | 838 | 360 |
| | | raw metal | | | |
| | | powder | | | |
| PMMA | 5 wt % in 2- | Vac. debind | 300 | 1619 | 760 |
| | methoxy- | Vac. debind/ | 1310 | 893 | 220 |
| | ethanol | vac. sintered | | | |
| PMMA | 7 wt % in 2- | Vac. debind | 325 | 1571 | 690 |
| | methoxy- | Vac. debind/ | 1310 | 820 | 170 |
| | ethanol | vac. sintered | | | |
| PMMA | 7 wt % in 2- | Vac. debind | 325 | 1697 | 750 |
| | methoxy- | Vac. debind/ | 1310 | 840 | 200 |
| | ethanol, | vac. sintered | | | |
| | w/0.35 wt % | | | | |
| | Variquat | | | | |
| | CC-42NS | | | | |

As discussed above, the reversible binders disclosed herein may be used in binder jetting additive manufacturing to print an article that may be used in machinery. The reversible binders may include thermoplastic or thermoset polymers that when heated above a decomposition temperature, the polymers form decomposition products (e.g., oligomers) that are relatively stable at a lower debinding temperature, and are readily removed from the metal part at higher (e.g., pre-sintering, sintering) temperatures. The decomposition products may include oligomers that remain in the article after debinding and improve the strength of the brown body metal part. In this way, the integrity of the brown body metal part may be maintained until the article is sintered. Additionally, the oligomers are readily and cleanly decomposed in a pre-sintering step without charring. In this way, the consolidated metal part may be substantially free of char residue, which may deleteriously affect the material properties of the consolidated metal part.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of binder jet printing a metal part comprising:
depositing a layer of a metal powder on a working surface of a binder jet printer;
selectively printing a binder solution comprising a reversible binder into the layer of metal powder in a pattern to generate a printed layer, wherein the pattern is representative of a structure of a layer of the metal part;
curing the reversible binder in the printed layer to generate a layer of a green body metal part;
heating the green body metal part above a first temperature to remove a substantial portion of the reversible binder and generate a brown body metal part, wherein the reversible binder is thermally decomposed to generate oligomers that remain within and strengthen the brown body metal part; and
heating the brown body metal part above a second temperature to remove the oligomers and sinter the metal powder to generate the metal part, wherein the metal part is substantially free of char residue.

2. The method of binder jet printing the metal part of claim 1, wherein the metal powder comprises a nickel alloy, a titanium alloy, a cobalt alloy, aluminum-based material, tungsten, stainless steel, or a combination thereof.

3. The method of binder jet printing the metal part of claim 1, wherein the layer of metal powder has a thickness of between approximately 10 microns and approximately 200 microns.

4. The method of binder jet printing the metal part of claim 1, wherein between approximately 98% and approximately 99.95% of the reversible binder is removed when heating the green body metal part above the first temperature.

5. The method of binder jet printing the article of metal part 1, wherein the reversible binder comprises a polyethylenic polymer, a mono-functional acrylic polymer, a di-acrylic polymer, a tri-acrylic polymer, poly(alkylene carbonates), co-polymeric alkylene carbonates, or combinations thereof.

6. The method of binder jet printing the metal part of claim 1, wherein the reversible binder consists of polymethylmethacrylate (PMMA), polystyrene, polyvinylalcohol (PVA), and poly(alkylene carbonate).

7. The method of binder jet printing the metal part of claim 1, wherein the reversible binder is derived from monomers consisting of hexanediol diacrylate (HDDA), trimethylolpropane (TMPTA), and diethylene glycol diacrylate (DGD).

8. The method of binder jet printing the metal part of claim 1, wherein the binder solution comprises between approximately 0.5 weight percent (wt %) and approximately 30 wt % of the reversible binder.

9. The method of binder jet printing the metal part of claim 1, wherein the binder solution comprises a mixture of the reversible binder and a solvent, and wherein curing the printed layer comprises evaporating the solvent.

10. The method of binder jet printing the metal part of claim 1, wherein the binder solution comprises one or more polymerizable monomers, and wherein curing the printed layer comprises polymerizing the one or more polymerizable monomers to form the reversible binder.

11. The method of binder jet printing the metal part of claim 1, wherein selectively printing comprises selectively printing the binder solution with a print head of the binder jet printer.

12. The method of binder jet printing the metal part of claim 1, comprising drying the green body before heating the green body to the first temperature to remove residual solvent used in the binder solution from the green body.

13. The method of binder jet printing the metal part of claim 1, comprising reducing the porosity of the metal part such that the metal part has a density between approximately 93% and approximately 99%.

14. The method of binder jet printing the metal part of claim 1, wherein the metal powder comprise particles having a particle size distribution that is between approximately 1 micron (μm) and 75 μm.

15. A metal part manufactured via a binder jet printing process comprising the steps of:
depositing a layer of a metal powder on a working surface of a binder jet printer;
selectively printing a binder solution configured for binder jetting into the layer of metal powder in a pattern representative of a structure of a layer of the metal part to generate a printed layer, wherein the binder solution comprises a reversible binder;
curing the printed layer to generate a green body metal part comprising the reversible binder;
heating the green body metal part above a first temperature to remove a substantial portion of the reversible binder and to generate a brown body metal part comprising oligomers, wherein the reversible binder is thermally decomposed to generate the oligomers; and
heating the brown body metal part above a second temperature to remove the oligomers and sinter the metal powder to generate the metal part, wherein the metal part is substantially free of char residue.

16. The metal part of claim 15, wherein the brown body metal part comprises between approximately 0.05% and approximately 2% of the oligomers.

17. The metal part of claim 15, wherein a carbon content of the metal part is substantially the same or less than a carbon content of the metal powder.

18. The metal part of claim 15, wherein the oxygen content of the metal part is substantially the same or less than the oxygen content of the metal powder.

19. A binder solution configured for use in binder jet printing, comprising:
a reversible binder comprising a polymer configured to thermally decompose into oligomers at a temperature range between approximately 75 (degrees Celsius (° C.) and approximately 500° C., and wherein the oligomers are configured to thermally decompose into volatile molecules that leave no char residue at a temperature range of between approximately 500° C. and approximately 1000° C.

20. The binder solution of claim 19, wherein the reversible binder consists of a polyethylenic polymer, a mono-functional acrylic polymer, a di-acrylic polymer, a tri-acrylic polymer, poly(alkylene carbonates), co-polymeric alkylene carbonates, or combinations thereof.

21. The binder solution of claim 19, wherein the reversible binder is polymerized from one or more polymerizable monomers consisting of hexanediol diacrylate (HDDA), trimethylolpropane (TMPTA), and diethylene glycol diacrylate (DGD).

22. The binder solution of claim 19, comprising between approximately 0.5 weight percent (wt %) and approximately 30 wt % of the reversible binder.

23. The binder solution of claim 19, comprising a solvent, viscosity modifier, surfactant, or a combination thereof.
